(19) United States
(12) Patent Application Publication
(10) Pub. No.: US 2011/0296159 A1
(43) Pub. Date: Dec. 1, 2011

(54) PXE SERVER AND ELECTRONIC DEVICE AND METHOD OF DISKLESS BOOTING ELECTRONIC DEVICE

(75) Inventors: XUE-WEN HONG, Shenzhen City (CN); TAN-KE LUO, Shenzhen City (CN)

(73) Assignees: HON HAI PRECISION INDUSTRY CO., LTD., Tu-Cheng (TW); HONG FU JIN PRECISION INDUSTRY (shenZhen) CO., LTD., Shenzhen City (CN)

(21) Appl. No.: 13/030,150

(22) Filed: Feb. 18, 2011

(30) Foreign Application Priority Data
May 28, 2010 (CN) 201010186018.7

(51) Int. Cl. G06F 9/24

(52) U.S. Cl. 713/2

(57) ABSTRACT

A method of diskless booting an electronic device sends a request for an IP address of the electronic device to a pre-boot execution environment (PXE) server. After receiving the request, the PXE server allocates an IP address to the electronic device, and sends a bootstrap program to the electronic device. The electronic device receives a configuration file of the electronic device from the PXE server, and executes one or more operating system kernels of the configuration file.

### BACKGROUND

1. Technical Field

The present disclosure relate to methods for a booting system, and more particularly, to a system and a method of diskless booting an electronic device.

2. Description of Related Art

If a pre-boot execution environment (PXE) server wants to mount file systems to an electronic device, an IP address of the electronic device has to be associated with a media access control (MAC) address of the electronic device. Namely, the MAC address of the electronic device is needed when the electronic device is started. A user may have to spend money on a network device to obtain the MAC address.

### BRIEF DESCRIPTION OF THE DRAWINGS

FIG. 1 is a block diagram of an exemplary embodiment of a server and an electronic device.

FIG. 2A and FIG. 2B are a flowchart of an exemplary embodiment of a method of diskless booting the electronic device in FIG. 1.

### DETAILED DESCRIPTION

The disclosure is illustrated by way of examples and not by way of limitation in the fingers of the accompanying drawings in which like references indicate similar elements. It should be noted that references to “an” or “one” embodiment in this disclosure are not necessarily to the same embodiment, and such references mean at least one.

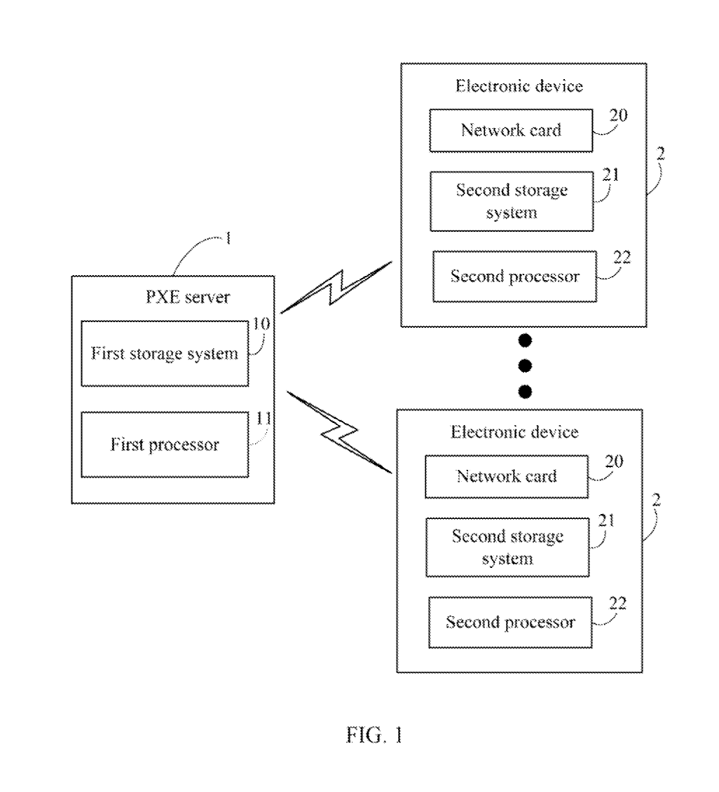

FIG. 1 is a block diagram of an exemplary embodiment of a pre-boot execution environment (PXE) server 1 and a plurality of electronic devices 2. Each electronic devices 2 includes a network card 20. The network card 20 supports a PXE protocol. The network card 20 of each electronic device 2 connects to the PXE server 1 via a network.

The PXE server 1 includes a first storage system 10 and at least one first processor 11. The first storage system 10 stores operating system files and a bootstrap program. In an exemplary embodiment, the operating system files may be Linux operating system files. The bootstrap program may be in connection with a booting process of the operating system and arranges for the orderly startup of the CPU and related electronic components of the electronic device 2. Each of the operating system files includes a plurality of operating system kernels and a plurality of file systems.

The first storage system 10 further stores a plurality of IP addresses, a configuration file corresponding to each IP address, and a default configuration file. In an exemplary embodiment, the default file may be named as “default.” The configuration file corresponding to each IP address is named as a hex value of each IP address. For example, if the IP address is 192.168.49.70, the configuration file corresponding to the IP address is named as C0A83146. Each configuration file stores a name, an address and startup parameters of each operating system kernel. The startup parameters of the operating system kernel may include a file system name and a memory address of the file system. In an exemplary embodiment, the memory address of the file system may be an address allocated by a memory of the electronic device 2.

If the electronic device 2 sends an IP address request to the PXE server 1, the PXE server 1 allocates an IP address stored in the first storage system 10 to the electronic device 2 according to a dynamic host configuration protocol (DHCP). Each electronic device 2 is allocated its own IP address. After being allocated the IP address, the electronic device 2 sends a bootstrap program request to the PXE server 1. The PXE server 1 sends the bootstrap program to the electronic device 2 according to a trivial file transfer protocol (TFTP).

The electronic device 2 executes the bootstrap program and sends a request command for configuration files to the PXE server 1. The request command includes the IP address of the electronic device 2. The PXE server 1 detects if there is a configuration file named as the IP address of the electronic device 2 in the first storage system 10 according to the request command using the PXE protocol. If there is a configuration file named as the IP address of the electronic device 2 in the first storage system 10, the PXE server 1 sends the configuration file to the electronic device 2 using TFTP. The electronic device 2 selects one or more operating system kernel names and startup parameters in the configuration file. The PXE server 1 downloads one or more operating system kernels corresponding to the one or more operating system kernel names to the electronic device 2. The electronic device 2 executes the one or more operating system kernels. The PXE server 1 mounts the file systems corresponding to the startup parameters on the electronic device 2. In an exemplary embodiment, the mounting may be a process of making a file system ready for use by the operating system.

In an exemplary embodiment, each electronic device 2 includes a second storage system 21 and at least one processor 22. The PXE server 1 and the plurality of electronic devices 2 may include one or more modules. The one or more modules may comprise computerized code in the form of one or more programs that are stored in the first storage system 10 and the second storage system 21 (or memory). The computerized code includes instructions that are executed by the at least one first processor 11 and second processor 22 to provide functions for the one or more modules.

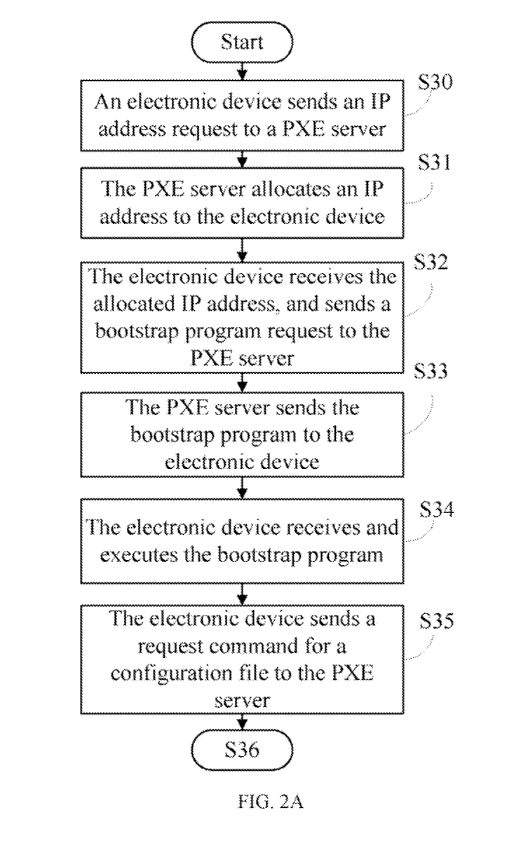

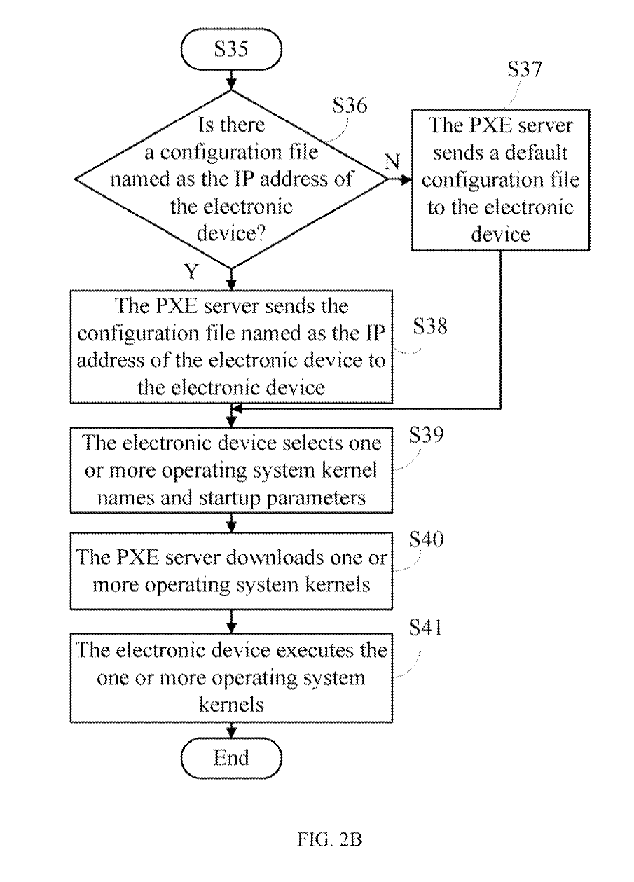

FIG. 2A and FIG. 2B are a flowchart of an exemplary embodiment of a method of diskless booting the electronic device 2. Depending on the embodiment, additional blocks may be added, others removed, and the ordering of the blocks may be changed.

In block S30, the electronic device 2 sends an IP address request to the PXE server 1.

In block S31, the PXE server 1 allocates an IP address stored in the first storage system 10 to the electronic device 2.

In block S32, the electronic device 2 receives the allocated IP address, and sends a bootstrap program request to the PXE server 1.

In block S33, the PXE server 1 sends the bootstrap program to the electronic device 2 according to the TFTP.

In block S34, the electronic device 2 receives and executes the bootstrap program.

In block S35, the electronic device 2 sends a request command for a configuration file to the PXE server 1.

In block S36, the PXE server 1 detects if there is a configuration file named as the IP address of the electronic device 2 in the first storage system 10. In an exemplary embodiment, the configuration file may be named as a hex value of the IP address. If there is a configuration file named as the IP address of the electronic device 2, block S38 is implemented. If there is no configuration file named as the IP address of the electronic device 2, block S37 is implemented.

In block S37, the PXE server 1 sends the default configuration file stored in the first storage system 10 to the electronic device 2.

In block S38, the PXE server 1 sends the configuration file named as the IP address of the electronic device 2 to the electronic device 2 using the TFTP.

In block S39, the electronic device 2 selects one or more operating system kernel names and startup parameters corresponding to the one or more kernel names.

In block S40, the PXE server downloads one or more operating system kernels corresponding to the one ore more operating system kernel names to the electronic device 2.

In block S41, the electronic device 2 executes the one or more operating system kernels. The PXE server 1 mounts the file systems corresponding to the startup parameters of the one or more operating system kernels in the electronic device 2.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A method of diskless booting an electronic device, comprising:
receiving a request for an IP address sent from the electronic device, and allocating an IP address to the electronic device by a pre-boot execution environment (PXE) server;
sending a bootstrap program request to the PXE server by the electronic device;
receiving and executing a bootstrap program sent from the PXE server by the electronic device;
receiving a request command for a configuration file of the electronic device, and sending the configuration file to the electronic device by the PXE server, the configuration file comprising operating system kernels of the electronic device and startup parameters;
downloading an operating system kernel selected from the configuration file to the electronic device by the PXE server; and
executing the operating system kernel by the electronic device, and mounting a file system corresponding to the startup parameters on the electronic device by the PXE server.

2. The method as claimed in claim 1, wherein the configuration file is named as a hex value of the IP address of the electronic device.

3. The method as claimed in claim 2, further comprising:
sending a default configuration file stored in a storage system of the PXE server to the electronic device if there is no configuration file named as the hex value of the IP address of the electronic device.

4. The network device as claimed in claim 1, wherein the startup parameters comprises file system names of the one or more operating system kernels and addresses of the file systems.

5. An electronic device, comprising:
a storage system;
at least one processor; and
one or more programs being stored in the storage system and executable by the at least one processor, the one or more programs comprising instructions:
to send an IP address request to a pre-boot execution environment (PXE) server and send a bootstrap program request to the PXE server after receiving an allocated IP address;
to execute the bootstrap program and send a request command for a configuration file to the PXE server;
to receive the configuration file from the PXE server, the configuration file comprising operating system kernel names of the electronic device and startup parameters;
to receive an operating system kernel corresponding to a selected operating system kernel name; and
to execute the operating system kernel and be mounted a file system corresponding to the start up parameters by the PXE server.

6. The electronic device as claimed in claim 5, wherein the configuration file is named as a hex value of the IP address of the electronic device.

7. The electronic device as claimed in claim 5, wherein the electronic device further comprises a network card which supports a PXE protocol.

8. The electronic device as claimed in claim 5, wherein the startup parameters comprises file system names of the one or more operating system kernels and address of the file systems.

9. A pre-boot execution environment (PXE) server, comprising:
a storage system;
at least one processor; and
one or more programs being stored in the storage system and executable by the at least one processor, the one or more programs comprising instructions:
to receive a request for an IP address from an electronic device, allocate an IP address to the electronic device, and send a bootstrap program to the electronic device;
to receive a request command for a configuration file of the electronic device, and send the configuration file to the electronic device, the configuration file comprising operating system kernels of the electronic device and startup parameters; and
to download an operating system kernels selected from the configuration file to the electronic device; and
to mount a file system corresponding to the startup parameters to the electronic device.

10. The PXE server as claimed in claim 9, wherein the configuration file is named as a hex value of the IP address of the electronic device.

11. The PXE server as claimed in claim 10, further to send a default configuration file stored in the first storage system to the electronic device if there is no configuration file named as the hex value of the IP address of the electronic device.

12. The PXE server as claimed in claim 9, wherein the startup parameters comprises file system names of the one or more operating system kernels and address of the file systems.
